(19) United States
(12) Patent Application Publication
(10) Pub. No.: US 2002/0174762 A1
(43) Pub. Date: Nov. 28, 2002

(54) Saxophone learning system

(76) Inventor: Anthony Derrick Cannon, St. Michaels, MD (US)

Correspondence Address: GREENBERG & LIEBERMAN, 314 PHILADELPHIA AVE., TAKOMA PARK, MD, 20912, US

(21) Appl. No.: 09/681,716

(22) Filed: May 24, 2001

(51) Int. Cl. G09B 15/00

(52) U.S. Cl. 84/484

(57) ABSTRACT

The present invention primarily presents itself as a teaching device for children or other beginning musicians particularly in saxophone instruction. The present invention is a stick like object that presents the fashion of a midriff of a saxophone with all fingering keys, and a weight at the base attached by a screw rod and a wingnut. Also contained within is a learning system for the student of the saxophone.

### BACKGROUND OF INVENTION

Beginning musical students of all ages have trouble learning the complexity of the instrument that they are attempting to master. It is much like learning a new language in developing technique of holding and producing notes on an instrument. Many musical aids are on the market that either assist a student in learning stringed or fretted instrument fingering techniques. There are also many aids intended to help keyboardists, or charts and calculators to help in transposition. As shown below none of these inventions can assist a saxophonist in fingering technique.

U.S. Pat. No. 5,709,552 issued to LeGrange on Jan. 20, 1998, presents a musical learning aid device that is different from the present invention in several manners. LeGrange's device is a musical chart fashioned much like a star, or navigational chart that rotates on several layers and is intended to help a student read sheet music and transpose music from one key to another. LeGrange's device is unlike the present invention in that; it is not a fingering system, but a rotational chart, it is intended to teach a student how to read music and recognize keys, not learn positions on a fingered instrument, and it is not specific to saxophones, or any other musical instrument, as is the present invention.

U.S. Pat. No. 5,639,977 issued to Hesnan on Jun. 17, 1997 shows a musical calculator. Hesnan's device is intended to teach children general sheet music reading and composition skills. Hesnan's invention is unlike the present invention in that it is not intended to teach fingering technique for instrument play, but is intended to display notes in a scale to aid in reading music.

U.S. Pat. No. 5,920,023 issued to Ravagni et al, issued Jul. 6, 1999 presents a musical learning aid that is specific only to stringed instruments that are played in a hand held fashion. This is inclusive of violins. basses., guitars, and is unlike the present invention because it does not address any teaching techniques for saxophone fingering instruction.

U.S. Pat. No. 4,417,497 issued to Nicklaus on Nov. 29, 1983; is a simulated fingerboard of a musical instrument. Nicklaus' invention is unlike the present invention in that it is only for stringed instruments, and it uses magnats to indicate correct fingering position, instead of spring weighted keys.

U.S. Pat. No. 5,038,662 issued to Ho on Aug. 13, 1991 is an electrical learning aid for teaching proper bowing techniques on stringed instruments. Ho's invention is unlike the present invention in that it is only for teaching bowing of stringed instruments, and is not intended for saxophones.

In U.S. Pat. Nos. 5,841,051 issued to Segan, on Nov. 24, 1998 is a musical learning aid specifically for children learning keyboarding techniques. Segan's invention is unlike the present invention in that it is only for keyboarding techniques as pertain to pianos and electric keyboards, and it is intended specifically for the instruction of children, and does not exhibit any method of fingering or play for a saxophone.

U.S. Pat. No. 6,018,117 issued to Harrison et al, on Jan. 25, 2000 is a system to teach keyboarding techniques to children. Harrison's invention is unlike the present invention in that it is solely for keyboarding purposes, and exhibits no method of instruction in saxophone play or technique.

U.S. Pat. No. 4,480,521 issued to Schmoyer on Nov. 6, 1984, exhibits a musical learning aid that differs from the present invention in that it is a method for perfecting fingering technique for a keyboard or organ, and shows no method of learning for a saxophone.

U.S. Pat. No. 4,428,269 issued to Bione et al, on Jan. 31, 1984, presents an aid intended for organ use only. Bione's device is also primarily computer as opposed to a representation of the instrument.

Lastly, U.S. Pat. No. 3,822,630 issued to Verna Leonard on Jul. 9, 1974 is a method of learning in which the student assigns each finger a number and uses these numbers to play scales. Leonard's invention is unlike the present invention in that it ais a method and apparatus for students to learn the scales by memorizing numbers associated with fingers and is not a system of fingering a saxophone.

Therefore a need has been established for a musical learning aid that is designed solely for use in teaching saxophone fingering techniques.

### SUMMARY OF INVENTION

The present invention primarily presents itself as a teaching device for children or other beginning musicians particularly in saxophone instruction. The present invention is a stick like object that presents the fashion of a midriff of a saxophone with all fingering keys, and a weight at the base attached by a screw rod and a wingnut. The saxophone learning system is soundless to take away from the frustration of a student by cacophonous sounds presented in beginning of learning saxophone fingering technique.

The present invention has a learning system to assist the beginning student in saxophone technique. The first step is choosing a scale, such as C Major, for the student to wotk on.The student is instrcted to first speak the name of the note aloud, e.g. “C”. The student should then press the key indicated as C on the tutor stick. The student should repeat these two steps, speaking aloud and pressing the key, a minimum of twenty-five times on each note, so that the key and the name of the note become one in the student's memory. The student should also ensure that their posture is correct and that they are holding their fingers in the correct curved position to create correct playing technique when the student's saxophone is played. At the end of practicing each note the student should then transfer to their saxophone and play the scale that they have just learned.

The present invention has also as an possible embodiment, an electronic pick up in the tutor stick to implement sound if the student wishes to practice tone at the same time as practicing fingering technique. The present invention will use conventional pick up technology for this function, and will be an optional addition, per student's request.

### BRIEF DESCRIPTION OF DRAWINGS

FIG. 1 shows the complete tutor stick as assembled.

FIG. 2 shows part of the tutor stick with a close up view of the attachment of the compensating weight disc.

FIG. 3 is a chart of the method of scale learning associated with the tutor stick.

FIG. 4 is a top view of the compensating weight disc attachment.

FIG. 5 is a cut away side view of the compensating weight disc attachment.

### DETAILED DESCRIPTION

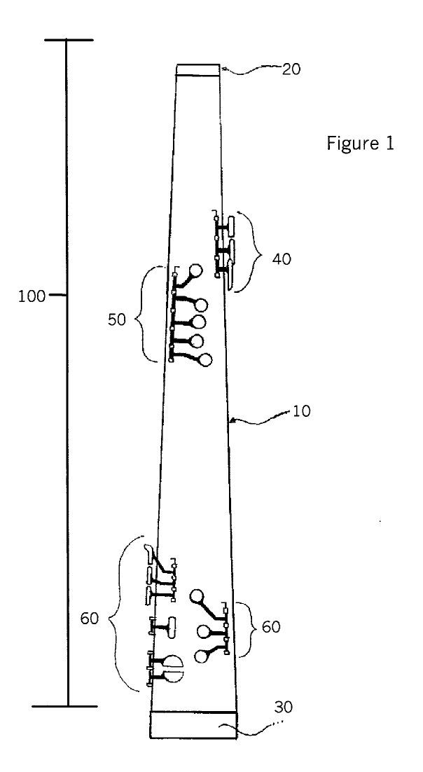

Starting with FIG. 1 we see the total tutor stick (100) as assembled. The unit base (10) can be fashioned to look exactly like a conventional saxophone, or appear as a smooth tubular member of consistent circumference. The end cap (20) provides a cover for the unit base (10), and protects the tutor stick (100) from dirt and debris. The compensating weight disc (30) is attached by a screw at the end of the unit base (10). The compensating weight disc (30) assures that the weight of the tutor stick (100) is the same as the type of saxophone that it is emulating; e.g tenor, soprano, etc. The compensating weight disc (30)is available in four gauges soprano gauge, alto gauge, tenor gauge, bass gauge. The soprano gauge, the alto gauge, the tenor gauge, and the bass gauge of the compensating weight disc (30)are equivalent to the difference in weight between an actual soprano, alto, tenor or bass saxophone, respectively, and the weight of the unit base (10), the palm keys(40), the left hand keys (50), the right hand keys (60), and the end cap (20). The palm keys (40), left hand fingering keys (50), and right hand fingering keys (60) are positioned and function in the same manner as a conventional saxophone.

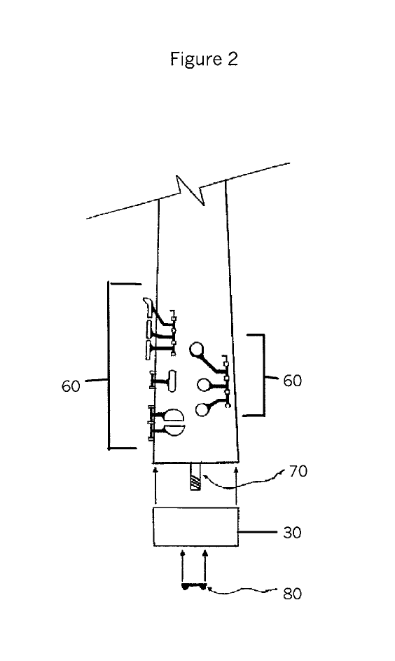

Moving to FIG. 2 we see a cut away view of tutor stick (100). We see the right hand fingering keys (60) as on a traditional saxophone. At the bottom of the unit base (10) is a screw rod (70) centered in the base. The screw rod (70) inserts into the compensating weight disc (30) and attaches to a wing nut (80) which secures the weight disc (30) to the unit base (10).

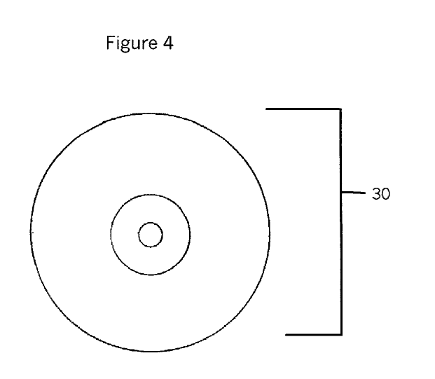

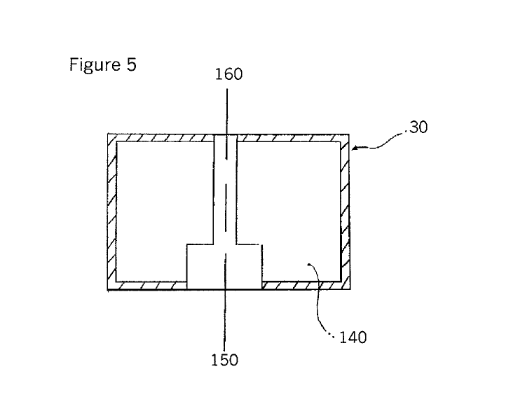

FIG. 4 shows a top view of the compensating weight disc (30) as it attaches to the unit base (10). Hole (160) provides a space for the screw rod (70) to attach to wing nut (80), thus adhering weight disc (30) to unit base (10). FIG. 5 shows a cut away side view of the compensating weight disc (30). Pellets of metal (140) assure that the weight disc (30) balance the tutor stick (100) to the appropriate degree of the saxophone being emulated. Again we see the hole (160) fashioned to fit screw rod (70) and the bottom (150) of weight disc (30). Bottom (150) is diveted to fit wing nut (80) to in turn adhere weight disc (30) to unit base (10).

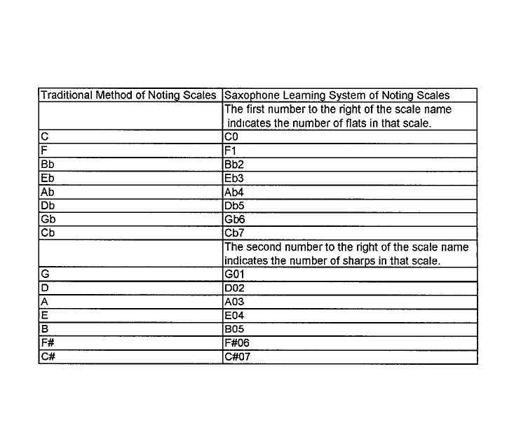

Returning to FIG. 3 we see an explanation of the accompanying musical theory system to expedite student's learning of scale systems. In traditional methodology (shown on the left side of the chart), the flat scales are sometimes marked with a “b” to indicate that they include at least one flat note. However the “b” is not used in the notation of every scale with at least one flat (See the F in traditional method column). The “b” also does not indicate the number of flat notes in that scale, only that there is at least one flat note. In the present invention a methodology is set up that a numeral of the amount of flats in the scale is marked at the end of the scale name. For example, instead of “Cb” in traditional methodology the student of the present methodology will see “Cb7” to mark that there are seven flat notes in that scale.

Also as a method of the present invention, is a system for marking the number of sharp notes in a scale. As shown in FIG. 3 the traditional method of marking sharps is a “#” at the end of the scale name. However, the traditional method does not mark all scales that contain sharp notes with a “#”, see G,D,A,E, and B. In the present invention's methodology, we see that the sharps are indicated by the second numeral from the end of the scale name. For example instead of F#, in the traditional method, a student of the present invention sees F#06 to indicate there are no flat notes and six sharp notes in the scale of F#.

Not shown in the figures is the optional sound pick up used with the saxophone tutor system. Students and instructors may then listen to the practice session, or by means of a microchip, and conventional download technology save the information and listen to the practice session later from a personal computer.

Primarily, the present invention is intended to be a learning device and system of learning for the saxophone, but is not exclusively limited thereto. It is to be understood that the present invention is not limited to the sole embodiment described above, but encompasses any and all embodiments within the scope of the following claims.

1. A tutor stick for teaching a user how to play a saxophone, comprising:
a unit base having a top and a bottom end;
an end cap, covering said top end of said unit base;
a compensating weight disc, removably attached to said bottom end of said unit base;
a set of palm keys, attached to said top end of said unit base, below said end cap;
a set of left hand fingering keys, attached to said unit base, below said set of palm keys; and
a set of right hand fingering keys, attached to said unit base, below said set of left hand fingering keys and above said compensating weight disc.

2. A tutor stick as in claim 1, further comprising a sound amplification device in communication with said unit base.

3. A tutor stick as in claim 2, wherein said sound amplification device communicates with a speaker.

4. A tutor stick as in claim 2, wherein said sound amplification device communicates with a computer to play a recording in a music software program.

5. A tutor stick as in claim 1, further comprising a screw communicating with said compensating weight disc and said bottom end of said unit base, allowing said compensating weight disc to removably attach to said unit base.

6. A tutor stick as in claim 1, wherein said compensating weight disc is chosen from the group: soprano gauge, alto gauge, tenor gauge, and bass gauge.

7. A tutor stick as in claim 1, wherein said set of palm keys, said set of left hand fingering keys, and said set of right hand fingering keys are spring loaded to emulate the feel of keys the saxophone.

8. A tutor stick as in claim 1, wherein said set of palm keys, said set of left hand fingering keys, and said set of right hand fingering keys correspond to the saxophone.

9. A scale notation method for marking a scale, comprising;
noting the number of sharp notes in the scale; and
noting the number of flat notes in the scale.
